(19) United States
(12) Patent Application Publication
(10) Pub. No.: US 2015/0225505 A1
(43) Pub. Date: Aug. 13, 2015

(54) COPOLYAMIDE, COMPOSITION COMPRISING SUCH A COPOLYAMIDE AND USES THEREOF

(71) Applicant: ARKEMA FRANCE, Colombes (FR)

(72) Inventors: Philippe Blondel, Bernay (FR); Thierry Briffaud, Caorches Saint Nicolas (FR)

(73) Assignee: ARKEMA FRANCE, Colombes (FR)

(21) Appl. No.: 14/425,957

(22) PCT Filed: Aug. 27, 2013
(86) PCT No.: PCT/FR2013/051972

§ 371 Date: Mar. 4, 2015

(30) Foreign Application Priority Data
Sep. 4, 2012 (FR) 12.58232

(51) Int. Cl. C08G 69/36

(52) U.S. Cl. CPC C08G 69/36; C08G 2410/00

(57) ABSTRACT

A copolyamide including at least two different repeat units having the following general formulation: A/X.Y, in which A is an aliphatic repeat unit selected from a unit obtained from at least one amino acid and a unit obtained from at least one lactam, and X.Y is a repeat unit obtained from the polycondensation of at least one cycloaliphatic diamine and at least one dicarboxylic acid. The proportion by weight of unit A is greater than or equal to 91%. Also, a composition including such a copolyamide and uses thereof, in particular in the soles of sports footwear.

The present invention relates to a copolyamide, to a process for preparing it and to the uses thereof, especially in the manufacture of various objects combining transparency, ease of decoration and mechanical strength with respect to repeated stress. Among these objects, mention may be made of common consumer goods such as sports articles and more particularly sports footwear.

The invention also relates to a composition comprising such a copolyamide, and also to the uses of this composition, especially in the manufacture of all or part of the objects mentioned above.

Finally, the present invention relates to footwear, and especially sports footwear, using this copolyamide or this composition.

### PRIOR ART AND TECHNICAL PROBLEM

In the field of footwear, and especially in the sports field, it is currently sought to make soles that are relatively rigid, which satisfy a fatigue test known as the “Ross Flex” test, and which are also transparent.

In the present description, the term “sole” means the sole in its generally accepted sense, but also elements of the footwear and of the shock-absorbing system, and especially the intermediate sole or the outer sole.

Various thermoplastic polymers are currently available on the market for making sports footwear soles. Among these polymers, polyamides are commonly used, in particular amorphous polyamides. Such polyamides are particularly advantageous since they have very good mechanical properties and are also transparent. However, they do not satisfy the “Ross Flex” fatigue test and therefore cannot be used for making parts subjected to repeated flexure.

Other transparent polymers, which moreover satisfy the fatigue test, are commonly used for making sports footwear soles: these are copolymers containing polyamide blocks and polyether blocks, known under the trade name Pebax®. However, these polymers are too flexible with regard to the required demands.

There is thus a real need to find a polymer that can simultaneously satisfy the three criteria mentioned above, namely:
be sufficiently rigid and have a flexural modulus of between 1000 and 1500 MPa (measured according to standard ISO . . . ),
be transparent, i.e. have a coefficient of light transmission of greater than or equal to 75% (measured at a wavelength of 560 nm and for a plate thickness of 2 mm), and
satisfy the “Ross Flex” fatigue test which will be detailed later.

Document US 2008/0 119 632 describes a transparent composition comprising a copolyamide for making printable transparent articles. These articles are more particularly in the form of films intended to make ski uppers. The copolyamide of the composition comprises:
from 65 mol% to 99 mol% of an equimolar mixture composed of a linear aliphatic diamine and of a linear aliphatic dicarboxylic acid, this mixture comprising a mean number of carbon atoms of between 8 and 12,
from 1 mol% to 35 mol% of an equimolar mixture of a cycloaliphatic diamine and of a dicarboxylic acid.

Such a copolyamide satisfies the three criteria of rigidity, transparency and fatigue mentioned above. However, the conversion or forming of such a copolyamide by molding is not entirely satisfactory. Specifically, not only is the formation of bubbles observed in the molded mass, but also the mold-stripping operation is difficult, since the copolyamide sticks to the walls of the mold. Consequently, the use of such a copolyamide for making footwear soles by molding is not envisageable.

The aim of the present invention is thus to propose a polymer that simultaneously satisfies the above three criteria of rigidity, transparency and fatigue and that can be readily used by molding, in particular for making molded articles such as a footwear sole.

### BRIEF DESCRIPTION OF THE INVENTION

This aim is achieved by a copolyamide comprising at least two different repeating units corresponding to the following general formula:

A/X.Y

in which:
A is an aliphatic repeating unit chosen from a unit obtained from at least one amino acid and a unit obtained from at least one lactam, and
X.Y denotes a repeating unit obtained from the polycondensation of at least one cycloaliphatic diamine and of at least one dicarboxylic acid comprising from 4 to 36 carbon atoms and advantageously from 6 to 18 carbon atoms.

According to the invention, the weight proportion of unit A in the copolyamide A/X.Y is greater than or equal to 91%.

Specifically, it is observed that at and above a weight content of 91% of repeating unit A in the copolyamide A/X.Y, the repeating units A and X.Y being as defined above, the rigidity, transparency and fatigue criteria are achieved, irrespective of the transformation conditions. In particular, implementation by molding is entirely satisfactory: no warpage of the molded mass is observable. For a weight content of less than 91%, it is observed, on the other hand, that the copolyamide no longer satisfies the “Ross Flex” fatigue test.

Other characteristics, aspects, subjects and advantages of the present invention will emerge even more clearly on reading the description and the examples that follow.

In particular, the present invention also relates to a process for preparing a copolyamide, to the uses thereof and also to a composition comprising such a copolyamide and to the uses of such a composition.

The present invention also relates to footwear, and especially to sports footwear.

It is pointed out that the terms “between . . . and . . . ” and “comprising from . . . to . . . ” used in the preceding paragraphs, but also in the rest of the present description, should be understood as including each of the mentioned limits.

### DETAILED DESCRIPTION OF THE INVENTION

The copolyamide according to the invention comprises at least two different repeating units corresponding to the following general formula:

A/X.Y

in which:
A is an aliphatic repeating unit chosen from a unit obtained from at least one amino acid and a unit obtained from at least one lactam, and
X.Y denotes a repeating unit obtained from the polycondensation of at least one cycloaliphatic diamine and of at least one dicarboxylic acid comprising from 4 to 36 carbon atoms and advantageously from 6 to 18 carbon atoms.

In the copolyamide A/X.Y, the weight proportion of repeating unit A is greater than or equal to 91%. Consequently, the content of repeating unit X.Y is less than or equal to 9%.

This weight proportion of unit A is advantageously between 91.5% and 99%, advantageously from 91.5% to 97%, more preferentially between 92% and 95%, particularly from 92% to 94% and advantageously from 92% to 93.3%, the remainder to 100% corresponding to the weight proportion of the repeating unit X.Y.

### Repeating Unit A

In a first variant of the invention, the repeating unit A is obtained from an aminocarboxylic acid comprising from 9 to 12 carbon atoms. It may thus be chosen from 9-aminononanoic acid (noted 9), 10-aminodecanoic acid (noted 10), 11-aminoundecanoic acid (noted 11) and 12-aminododecanoic acid (noted 12).

Preferentially, the repeating unit A is obtained from 11-aminoundecanoic acid (11).

In a second variant of the invention, the repeating unit A is obtained from a lactam comprising from 9 to 12 carbon atoms. It may thus be chosen from decanolactam (noted 10), undecanolactam (noted 11) and laurolactam or lauryllactam (noted 12).

Preferentially, the repeating unit A is obtained from lauryllactam (12).

More particularly preferably, the repeating unit A is obtained from a single aminocarboxylic acid or a single lactam.

However, it may be entirely envisaged to use, in order to obtain this same unit A, a mixture of two or more aminocarboxylic acids, a mixture of two or more lactams, but also a mixture of one, two or more aminocarboxylic acids with one, two or more lactams.

### Repeating Unit X.Y

The repeating unit X.Y is a unit obtained from the polycondensation of at least one cycloaliphatic diamine and of at least one dicarboxylic acid.

The mole proportions of cycloaliphatic diamine and of dicarboxylic acid are preferentially stoichiometric.

The cycloaliphatic diamine and the dicarboxylic acid each comprise from 4 to 36 carbon atoms and advantageously from 6 to 18 carbon atoms.

The cycloaliphatic diamine may be chosen from bis(3,5-dialkyl-4-aminocyclohexyl)methane, bis(3,5-dialkyl-4-amino cyclohexypethane, bis(3,5-dialkyl-4-aminocyclohexyl)propane, bis(3,5-dialkyl-4-amino cyclohexyl)butane, bis(3-methyl-4-aminocyclohexyl)methane or 3′-dimethyl-4,4′-diamino-dicyclohexylmethane, commonly referred to as BMACM or MACM (and noted B below), p-bis(aminocyclohexyl)methane, commonly referred to as PACM (and noted P below), isopropylidenedi(cyclohexylamine) commonly referred to as PACP, isophoronediamine (noted IPD below) and 2,6-bis(aminomethyl)norbornane, commonly referred to as BAMN.

Advantageously, the cycloaliphatic diamine of the unit X.Y is chosen from 3,3′-dimethyl-4,4′-diamino-dicyclohexylmethane (B), p-bis(aminocyclohexyl)methane (P) and isophoronediamine (IPD).

In an advantageous embodiment of the invention, the cycloaliphatic diamine of the unit X.Y is a bicycloaliphatic diamine, chosen in particular from 3,3′-dimethyl-4,4′-diamino-dicyclohexylmethane (B) and p-bis(aminocyclohexyl)methane (P).

The dicarboxylic acid may be chosen from linear or branched aliphatic dicarboxylic acids, cycloaliphatic dicarboxylic acids and aromatic dicarboxylic acids.

Advantageously, the dicarboxylic acid may be chosen from linear aliphatic dicarboxylic acids, cycloaliphatic dicarboxylic acids and aromatic dicarboxylic acids.

When the dicarboxylic acid is aliphatic and linear, it may be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanedioic acid (18), octadecenedioic acid (18), eicosanedioic acid (20), docosanedioic acid (22) and fatty acid dimers containing 36 carbon atoms.

The fatty acid dimers mentioned above are dimerized fatty acids obtained by oligomerization or polymerization of unsaturated monobasic fatty acids containing a long hydrocarbon chain (such as linoleic acid and oleic acid), as described especially in document EP 0 471 566.

In an advantageous version, the dicarboxylic acid of the unit X.Y is an aliphatic dicarboxylic acid chosen from adipic acid (6), decanedioic acid (10), dodecanedioic acid (12) and tetradecanedioic acid (14).

Among all the possible combinations for the copolyamides A/X.Y, when an aliphatic dicarboxylic acid is used, copolyamides corresponding to one of the formulae chosen from 11/B.6, 11/P.6, 11/IPD.6, 12/B.6, 12/P.6, 12/IPD.6, 11/B.10, 11/P.10, 11/IPD.10, 12/B.10, 12/P.10, 12/IPD.10, 11/B.14, 11/P.14, 11/IPD.14, 12/B.14, 12/P.14, 12/IPD.14, etc. will be selected in particular.

When the dicarboxylic acid is cycloaliphatic, it may comprise the following carbon backbones: norbornylmethane, cyclohexane, cyclohexylmethane, dicyclohexylmethane, dicyclohexylpropane, di(methylcyclohexyl) or di(methylcyclohexyl)propane.

When the dicarboxylic acid is aromatic, it may be chosen from terephthalic acid (noted T), isophthalic acid (noted I) and a naphthenic acid.

In an advantageous version, the dicarboxylic acid of the unit X.Y is an aromatic dicarboxylic acid, preferably isophthalic acid (I).

Among all the possible combinations for the copolyamides A/X.Y, when an aromatic dicarboxylic acid is used, copolyamides corresponding to one of the formulae chosen from 11/B.T, 11/B.I, 12/B.T, 12/B.I, 11/P.T, 11/P.I, 12/P.T, 12/P.I, 11/IPD.T, 11/IPD.I, 12/IPD.T and 12/IPD.I will be selected in particular, more particularly copolyamides corresponding to one of the formulae chosen from 11/B.T, 11/B.I, 12/B.T, 12/B.I, 11/P.T, 11/P.I, 12/P.T and 12/P.I, advantageously 11/B.T, 11/P.T, 11/P.I, 12/P.T and 12/P.I.

Advantageously, the repeating unit X.Y is obtained from at least one cycloaliphatic diamine, especially a bicycloaliphatic diamine, and from a single dicarboxylic acid, this dicarboxylic acid preferably being an aromatic dicarboxylic acid.

Preferably, the repeating unit X.Y is obtained from a single cycloaliphatic diamine, especially a bicycloaliphatic diamine, and from a single dicarboxylic acid, this dicarboxylic acid preferably being an aromatic dicarboxylic acid.

However, it may be entirely envisaged to use, in order to obtain this same repeating unit X.Y, a mixture of one, two or more cycloaliphatic diamines, especially a mixture of one, two or more bicycloaliphatic diamines with one, two or more dicarboxylic acids.

More particularly preferably, the copolyamide according to the invention consists of only two repeating units A and X.Y:
the repeating unit A being a unit obtained either from a single aminocarboxylic acid, or from a single lactam,
the repeating unit being obtained from the polycondensation of a single cycloaliphatic diamine, especially a single bicycloaliphatic diamine, and from a single dicarboxylic acid, this dicarboxylic acid preferably being an aromatic dicarboxylic acid.

The invention also relates to a process for preparing a copolyamide as defined above. This process comprises at least one step of polycondensation of the comonomers leading to the repeating units A and X.Y, i.e. it comprises at least one step of polycondensation of at least one aminocarboxylic acid and/or of at least one lactam with at least one cycloaliphatic diamine, especially a bicycloaliphatic diamine, and at least one dicarboxylic acid, especially a dicarboxylic acid chosen from linear aliphatic dicarboxylic acids, cycloaliphatic dicarboxylic acids and aromatic dicarboxylic acids.

The invention also relates to a composition comprising at least one copolyamide as described previously.

A composition in accordance with the invention may comprise, in addition to the copolyamide that has just been described, at least a second polymer.

Advantageously, this second polymer may be chosen from a semicrystalline polyamide, an amorphous polyamide, a semicrystalline copolyamide, an amorphous copolyamide, a polyetheramide, a polyetheramide and a polyesteramide, and mixtures thereof.

The composition according to the invention may also comprise at least one additive.

This additive may be chosen especially from fillers, fibers, dyes, stabilizers (especially UV stabilizers), plasticizers, impact modifiers, surfactants, pigments, optical brighteners, antioxidants and natural waxes, and mixtures thereof.

Among the fillers, mention may be made especially of talc, silica, carbon black, carbon nanotubes, expanded graphite, titanium oxide and glass beads.

The copolyamide according to the invention or the composition according to the invention may be used for making a structure.

This structure may be monolayer when it is formed only from the copolyamide or only from the composition according to the invention.

This structure may also be a multilayer structure when it comprises at least two layers and when at least one of the various layers forming the structure is formed from the copolyamide or from the composition according to the invention.

The structure, whether it is monolayer or multilayer, may especially be in the form of fibers, a film, a sheet, a tube, a hollow body, a molded part or an injection-molded part.

Such structures, in particular when they are in film or sheet form, may be decorated. These structures may be used for making objects, especially with the implementation of an over-injection molding step to produce parts.

The copolyamide according to the invention or the composition according to the invention may advantageously be used for the manufacture of a transparent molded article. Such an article may be a footwear sole or a constituent component of a footwear sole, in particular a sports footwear sole or an element of a sports footwear sole.

The copolyamide according to the invention or the composition according to the invention may also be used for the manufacture of a ski upper; in particular, the copolyamide or the composition may be transformed into films or sheets, the latter optionally being decorated, and then used via overmolding processes.

The copolyamide according to the invention or the composition according to the invention may also be used for the manufacture of photovoltaic panels.

Finally, the present invention relates to footwear, and especially sports footwear, this footwear comprising a sole. According to the invention, this sole consists totally or partly of the copolyamide or of the composition according to the invention.

It is recalled that, in the present text, the term “sole” means the sole in its generally accepted sense, but also elements of the footwear and of the shock-absorbing system, and especially the intermediate sole or the outer sole.

The present invention will now be described in the examples below, such examples being given for purely illustrative purposes and obviously being nonlimiting.

### EXAMPLES

### Preparation of Copolyamides I1 and I2 According to the Invention and Comparative Copolyamides C1 to C3

The comonomers used for the synthesis of polyamides I1, I2, C1, C2 and C3 are the following:
11-aminoundecanoic acid (noted All)
decanediamine (noted DA10)
decanedioic acid (noted DC10)
bis(3-methyl-4-aminocyclohexyl)methane (noted B)
isophthalic acid (noted I)
adipic acid (noted DC6)

The mole proportions and weight proportions of these various copolyamides are reported in Table 1 below.

The preparation process, which may be transposed to all synthesized copolyamides, will now be described in detail for copolyamide I1.

Copolyamide I1 was prepared from the weight contents of the following various compounds:
30.54 kg of 11-aminoundecanoic acid (25 mol)
1.45 kg of bis(3-methyl-4-aminocyclohexyl)methane (1 mol)
1.01 kg of isophthalic acid (1 mol)
214.5 g of stearic acid
6.6 g of hypophosphorous acid (H₃PO₂) at 50% in water
4 kg of water

The above comonomers are introduced into a 92 liter autoclave reactor, which, once closed, is rendered inert under nitrogen and heated with stirring (40 rpm) at 240° C. under a pressure of 30 bar. The pressure is then reduced to atmospheric pressure to obtain a temperature of 270° C. The reactor is then degassed by flushing with nitrogen to achieve the couple giving an inherent viscosity of 1.10 to 1.60 dl/g (the inherent viscosity being measured using 0.5 g of copolyamide dissolved at 25° C. in meta-cresol).

The copolyamide obtained is then extruded in the form of rods, cooled in a tank of water at room temperature, and then granulated.

The granules obtained are then dried at 80° C. for 12 hours under vacuum, to achieve a humidity content of less than 0.1%.

### Tests Performed

Measurement of the transparency: plates 2 mm thick were made from copolyamides I1, I2 and C1 to C3. The percentage of light transmitted or reflected at a wavelength of 560 nm on 2 mm plates prepared from the copolyamides was measured, according to standard ISO 13468. It is considered that the copolyamide is transparent at and above 70% light transmission.

Flexural modulus: tensile specimens were prepared from copolyamides I1, I2 and C1 to C3 to determine the flexural modulus values, in accordance with standard ISO 527. The desired flexural modulus should be between 1000 and 1500 MPa.

“Ross Flex” fatigue test: this test is performed in accordance with standard ASTM D1052. Parts 2 mm thick were prepared from copolyamides I1, I2 and C1 to C3. These parts were pierced with a hole 2.5 mm in diameter and then conditioned for 15 days at 23° C. and 50% relative humidity. By means of this “Ross Flex” test, the number of times after which breakage occurs when the part is folded at the hole to 60°, at a temperature of −10°, is determined. It is considered that the part satisfies the conditions of this test when the number of cycles is greater than or equal to 50 000.

Evaluation of the transformation by molding: copolyamides I1, I2 and C1 to C3 were injected, in a mold at 40° C., at a temperature of between 250 and 270° C. and maintained in this mold for 25 seconds. After a cooling time of 20 seconds, the parts were stripped from the molds. The observations made during the mold-stripping step and regarding the appearance of the molded parts are collated in Table 1 below.

TABLE 1

| | Examples | | | | |
|---|---|---|---|---|---|
| | C1 | C2 | C3 | I1 | I2 |
| A11 | 20 | — | — | 25 | 26 |
| DA10 | — | 10.75 | 13.5 | — | — |
| DC10 | — | 10.75 | 13.5 | — | — |
| B | 1 | 1 | 1 | 1 | 1 |
| I | 1 | 1 | 1 | 1 | — |
| DC6 | — | — | — | — | 1 |
| Unit A (weight %) | 90.8 | 90.8 | 92.6 | 92.5 | 93.1 |
| Transparency (%) | 80 | 90 | 85 | 80 | 78 |
| Flexural modulus (MPa) | 1175-1282 | >1000 | >1000 | 1142-1295 | >1000 |
| Ross Flex | breaks | breaks | >50 000 | >50 000 | >50 000 |
| Molding | ++ | — | bubbles, sticks | ++ | ++ |
| Warpage | yes | yes | no | no | no |

It is observed that copolyamides I1 and 12, in accordance with the invention, satisfy the criteria of transparency, rigidity and the “Ross Flex” test. In addition, in contrast with Comparative Example C3 in which the formation of bubbles in the molded material is observed and for which the mold-stripping step is made difficult by the fact that the copolyamide sticks to the walls of the mold, transformation by molding is entirely satisfactory. For copolyamides C2 and C3, it is observed that the product is slow to crystallize, which implies a long cycle time. In addition, traces of flow are observed on the molded parts.

1. A copolyamide comprising at least two different repeating units corresponding to the following formula:
A/X.Y
in which:
A is an aliphatic repeating unit chosen from a unit obtained from at least one amino acid and a unit obtained from at least one lactam, and
X.Y denotes a repeating unit obtained from the polycondensation of at least one cycloaliphatic diamine and of at least one dicarboxylic acid comprising from 4 to 36 carbon atoms,
wherein the weight proportion of unit A in the copolyamide A/X.Y is greater than or equal to 91%.

2. The copolyamide as claimed in claim 1, wherein the repeating unit A is obtained from an aminocarboxylic acid comprising from 9 to 12 carbon atoms.

3. The copolyamide as claimed in claim 1, wherein the repeating unit A is obtained from a lactam comprising from 9 to 12 carbon atoms.

4. The copolyamide as claimed in claim 1, wherein the cycloaliphatic diamine of the unit X.Y is chosen from 3,3′-dimethyl-4,4′-diamino-dicyclohexylmethane (B), p-bis(aminocyclohexyl)methane (P) and isophoronediamine (IPD).

5. The copolyamide as claimed in claim 1, wherein the dicarboxylic acid of the unit X.Y is an aliphatic dicarboxylic acid.

6. The copolyamide as claimed in claim 1, wherein the copolyamide corresponds to a formula selected from 11/B.6, 11/P.6, 11/IPD.6, 12/B.6, 12/P.6, 12/IPD.6, 11/B.10, 11/P.10, 11/IPD.10, 12/B.10, 12/P.10, 12/IPD.10, 11/B.14, 11/P.14, 11/IPD.14, 12/B.14, 12/P.14 and 12/IPD.14.

7. The copolyamide as claimed in claim 1, wherein the dicarboxylic acid of the unit X.Y is an aromatic dicarboxylic acid.

8. The copolyamide as claimed in claim 1, wherein the copolyamide corresponds to a formula selected from 11/B.T, 11/B.I, 12/B.T, 12/B.I, 11/P.T, 11/P.I, 12/P.T, 12/P.I, 11/IPD.T, 11/IPD.1, 12/IPD.T and 12/IPD.I.

9. A process for preparing the copolyamide as claimed in claim 1, wherein the process comprises a step of polycondensation of the comonomers leading to the repeating units A and X.Y.

10. A composition comprising at least one copolyamide as claimed in claim 1.

11. The composition as claimed in claim 10, wherein the composition further comprises at least one additive, this additive being chosen from fillers, fibers, dyes, stabilizers, especially UV stabilizers, plasticizers, impact modifiers, surfactants, pigments, optical brighteners, antioxidants and natural waxes, and mixtures thereof.

12. A monolayer structure or at least one layer of a multilayer structure comprising a copolyamide as claimed in claim 1.

13. The structure as claimed in claim 12, wherein the structure is in the form of fibers, a film, a sheet, a tube, a hollow body, a molded part or an injection-molded part.

14. A transparent molded article comprising a polyamide as claimed in claim 1.

15. Footwear, comprising a sole, said sole being made totally or partly from a copolyamide as claimed in claim 10.

16. The copolyamide as claimed in claim 1, wherein X.Y denotes a repeating unit obtained from the polycondensation of at least one cycloaliphatic diamine and of at least one dicarboxylic acid comprising from 6 to 18 carbon atoms.

17. The copolyamide as claimed in claim 1, wherein the repeating unit A is obtained from 11-aminoundecanoic acid.

18. The copolyamide as claimed in claim 1, wherein the repeating unit A is obtained from lauryllactam.

19. The copolyamide as claimed in claim 1, wherein the dicarboxylic acid of the unit X.Y is an aliphatic dicarboxylic acid chosen from adipic acid, dodecanedioic acid, tetradecanedioic acid and hexadecanedioic acid.

20. The copolyamide as claimed in claim 1, wherein the dicarboxylic acid of the unit X.Y is an aromatic dicarboxylic acid chosen from terephthalic acid (T), isophthalic acid (I) and a naphthenic acid.
